(19) United States
(12) Patent Application Publication
(10) Pub. No.: US 2011/0296331 A1
(43) Pub. Date: Dec. 1, 2011

(54) GENERATION OF A BEST-FIT RIGGED BODY MODEL

(75) Inventors: Manjula Ananthnarayanan Iyer, Kirkland, WA (US); Cole Brooking, Kirkland, WA (US); Nishant Dani, Redmond, WA (US); Pengpeng Wang, Redmond, WA (US); Pragyana K. Mishra, Kirkland, WA (US)

(73) Assignee: MICROSOFT CORPORATION, Redmond, WA (US)

(21) Appl. No.: 12/791,134

(22) Filed: Jun. 1, 2010

(51) Int. Cl. G06F 3/048

(52) U.S. Cl. 715/771; 715/780

(57) ABSTRACT

A best-fit rigged body model can be generated for a user based on body measurements provided by the user. Existing, and already known, rigged body models can be filtered, such as via a Principal Component Analysis to eliminate body models that are very similar in a measurement space whose dimensions are comprised of body measurements that can be, or actually were, collected from the user. The body measurements provided by the user can be expressed, in measurement space, as a combination of fractions of one or more existing body models. Such a combination can be computed through a Least Square Error analysis. A best-fit rigged body model can be generated for a user by amalgamating existing rigged body models in accordance with this previously determined combination of fractions of the one or more existing body models.

### BACKGROUND

The graphical display capabilities of modern computing devices are sufficiently advanced that they can display, in a realistic manner, images of clothing on a virtualized body. Such images can be of sufficient visual quality that they can provide utility when, for example, determining whether to purchase the clothing illustrated, such as from an online merchant, or when comparing multiple different articles of clothing or determining the look and fit of clothing via a computing device. Such images can also provide more realistic visual depictions within the context of video games, virtual reality simulations, or other like uses.

In many cases, the utility of this visualization of clothing on a virtualized body is dependent upon the similarity between the virtualized body and the user to whom this visualization is presented. For example, in the context of purchasing clothing, such as from an online retailer, the user's interest in viewing the visualization of the clothing on a virtualized body is in the making an informed judgment as to how such clothing might appear when worn by that user. Similarly, in the context of video games or virtual reality simulations, users' interest in viewing virtualized bodies is in envisioning themselves, or other people known to them, within the virtualized world of the video game or the virtual reality simulation.

Consequently, it can be desirable to generate a virtualized body, such that can be layered with clothing and that can be animated in a meaningful manner, that is commensurate with the user's own, physical, body. However, a virtualized body that can be used and animated in a meaningful manner in a virtualized three-dimensional environment is typically comprised of a three-dimensional mesh and rigging information. Such a three-dimensional mesh and rigging information can be very difficult to derive, with any meaningful accuracy, from information about a user's own, physical, body that a typical user would know and be able to provide, such as, for example, that user's height, girth, and weight.

### SUMMARY

In one embodiment, a best-fit rigged body model can be generated for a user based on user-specific body measurements that can be provided by the user and based on existing, and already known, rigged body models.

In another embodiment, the existing rigged body models can be filtered, such as via a Principal Component Analysis, or any other classification filter, to eliminate body models that are very similar, or essentially duplicative based on the body measurements that can be collected from the user, or even based on the body measurements that actually were collected from the user.

In a further embodiment, the user-specific body measurements can be expressed as a combination of fractions of one or more existing body models. These models can be generated using Principal Component Analysis. Such a combination can be computed through a Least Square Error analysis.

In a still further embodiment, a best-fit rigged body model can be generated for a user by amalgamating existing rigged body models in accordance with a previously determined combination of fractions of the one or more existing body models.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which

FIG. 1 is a block diagram of an exemplary system for generating a best-fit rigged body model for a user;

FIG. 2 is a block diagram of an exemplary mechanism for generating a best-fit rigged body model for a user;

FIG. 3 is a flow diagram of an exemplary mechanism for generating a best-fit rigged body model for a user; and

FIG. 4 is a block diagram of an exemplary computing device.

### DETAILED DESCRIPTION

The following description relates to the generation of a best-fit rigged body model for a user such that the generated rigged body model matches the user's physical body, or the physical body of an individual whose measurements were provided by the user for such a purpose. The best-fit rigged body model that is generated can be generated from a collection of one or more known, existing, rigged body models. Such a collection can be filtered, such as via Principal Component Analysis (PCA), or a classification filter, to eliminate body models that are very similar, or essentially duplicative. Such a determination of similarity can be based on the measureable body specifications, or even based on the actual body measurements, that can be, or are, collected from the user. The measurements of the filtered, rigged body models can then be compared to the measurements provided by the user so that the measurements provided by the user can be expressed as a combination of fractions of one or more of the rigged body models. A Least Square Error (LSE) analysis can be utilized to express the measurements provided by the user in the form of combination of factions of the one or more rigged body models. A best-fit rigged body model can then be generated based on the combination of fractions of the one or more known rigged body models.

While the below descriptions, directed to the generation of a best-fit rigged body model given body measurements, reference specific mathematical analysis, they are not so limited. Indeed, any analytic that can provide the required information can be utilized. Thus, while the below descriptions will make reference to specific ones, the scope of the descriptions encompasses the utilization of any analytic that can filter, and then compare the filtered information to user-provided information.

Although not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures, where data is maintained, are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

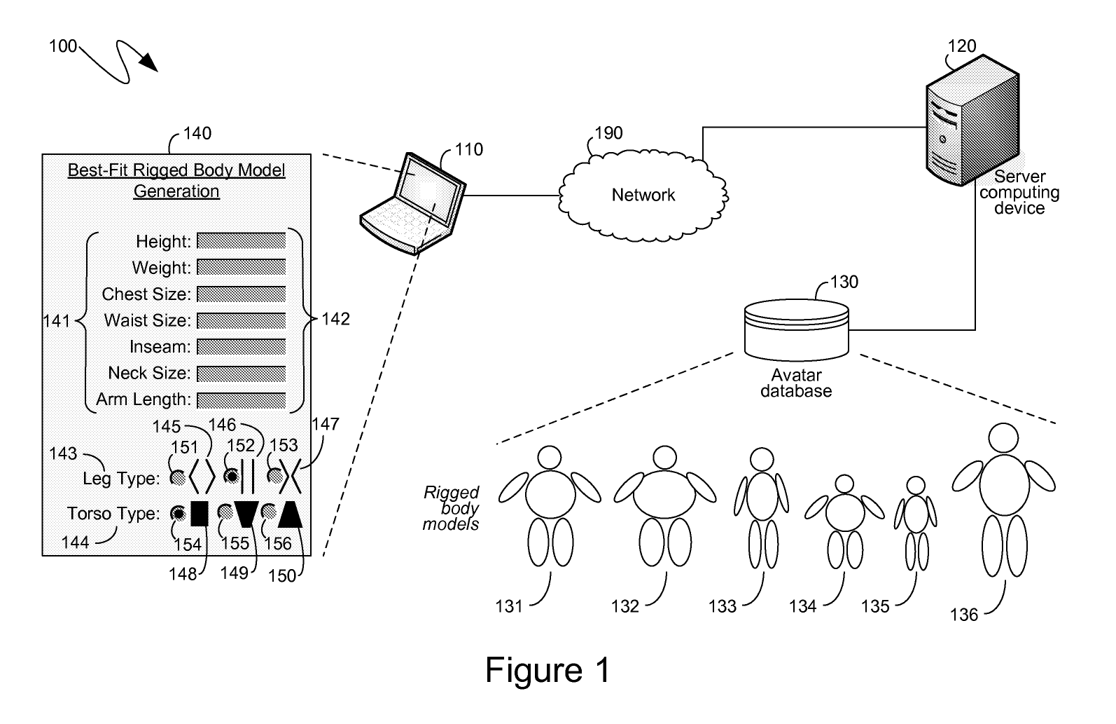

Turning to FIG. 1, a system 100 is shown, comprising two computing devices 110 and 120 that are communicationally coupled to one another via the network 190. In the illustrated embodiment, the computing device 110 can act as a client computing device, such as can be directly utilized by one or more users. Conversely, the computing device 120 can act as a server computing device that can provide information to, and receive information from, the client computing device 110, such as through communications transmitted across the network 190. In one embodiment, the server computing device 120 can be communicationally coupled to an avatar database 130 comprising known, existing, rigged body models of various types, graphically illustrated by the rigged body models 131, 132, 133, 134, 135 and 136. In an alternative embodiment, however, the avatar database 130 can either be accessed directly by the client computing device 110, such as via the network 190, or can even be locally stored on storage media communicationally coupled with the client computing device 110.

As shown in the system 100 of FIG. 1, the client computing device 110 can present a user interface 140 that can provide a mechanism through which a user can provide measurements regarding the physical human body for which the user wishes to generate a best-fit rigged body model. In one embodiment, the user interface 140 can comprise numerical entry mechanisms 142 corresponding to various body measurements 141 such as, for example, the height, weight, chest size, waist size, inseam, neck size, arm length, and other like body measurements. In another embodiment, the user interface 140 can comprise selection entry mechanisms 151, 152, 153, 154, 155 and 156 for selecting among a defined set of alternatives. For example, the leg type 143 of the physical human body for which a best-fit rigged body model is being generated can be selected from among three basic selections including, for example, a bowlegged selection 145, a straight-legged selection 146, and a knock-knees selection 147, that can be associated with the selection entry mechanisms 151, 152 and 153, respectively. Similarly, as another example, the torso type 144 of the physical human body for which a best-fit rigged body model is being generated can be selected from among three basic selections including, for example, a substantially rectangular torso 148, a broad-shouldered torso 149, and a broad-girth torso 150, that can be associated with the selection entry mechanisms 154, 155 and 156, respectively.

In the embodiment illustrated by the system 100 of FIG. 1, various measurements and other information regarding the physical human body for which the best-fit rigged body model will be generated can be collected by the client computing device 110 from a user entering such measurements and other information, and can be transmitted, by the client computing device 110, to the server computing device 120, such as by communications transmitted over the network 190. The server computing device 120 can then utilize the information provided by the client computing device 110, together with the rigged body models of the avatar database 130, to generate the best-fit rigged body model, such as in accordance with the mechanisms described in detail below. In an alternative embodiment, not specifically illustrated, the information regarding the physical human body for which the best-fit rigged body model will be generated can be both collected by the client computing device 110 and can be processed by the client computing device 110 to generate the best fit rigged body model, such as in accordance with the mechanisms described in detail below, and with reference to the avatar database 130, from which information can be received through communications, over the network 190, with the server computing device 120. In yet another alternative embodiment, again not specifically illustrated, the relevant information can, again, be both collected and processed by the client computing device 110, except that reference to the avatar database 130 need not comprise network communications, and the avatar database 130 can be directly stored on a storage medium communicationally coupled to the client computing device, such as a local hard disk drive, optical disk, or other like storage medium.

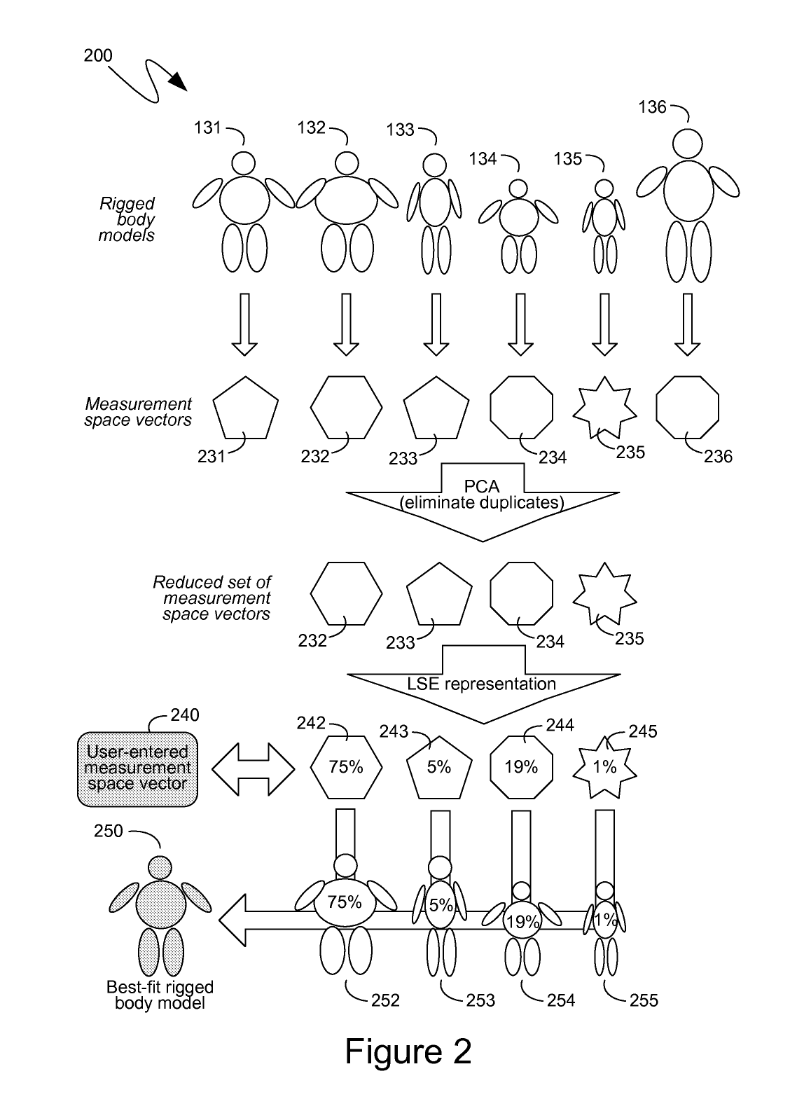

Turning to FIG. 2, the system 200 shown therein illustrates an exemplary series of mechanisms by which a best-fit rigged body model 250 can be generated in accordance with user-entered body measurements and other information from a set of known, existing rigged body models. Initially, as shown in the system 200 of FIG. 2, body measurements can be derived from the set of known rigged body models. As will be known by those skilled in the art, rigged body models can comprise point-by-point information for each of a multitude of points on a virtualized outline, or skeleton, of a human body. For example, for each point, blend weights, blend indices, and other like information can be part of the rigged body model, and such information can be utilized in generating virtualized three-dimensional representations of human bodies defined by the rigged body models. By referencing this point-by-point information, body measurements can be derived from a rigged body model. For example, the height and weight of the physical human body that is represented by the rigged body model can be derived, to at least some level of accuracy, from the information contained in the rigged body model that defines, in a fair bit of detail, the shape and attributes of the physical human body represented by that rigged body model. Likewise, waist size, hip size, neck size, and other like body measurements can similarly be derived from these known, existing rigged body models. Additionally, in one embodiment, the overall shape of the human body represented by a particular rigged body model can be quantified in an established manner. For example, specific body types or overall body shapes, or the shapes of individual body elements, such as those represented by the selections 143 through 150 shown in FIG. 1, can be associated with specific numeric quantities. Thus, in such an exemplary embodiment, leg type, for example, can be quantified on a scale of 1 to 10 where the numeric value of “1” represents a bowlegged leg shape and a numeric value of “10” represents a knock-kneed shape.

In one embodiment, the derived body measurements, and other quantitative representations of qualitative body shapes and types, can be represented in the form of a multidimensional vector whose magnitude along any direction is equivalent to the body measurement of value corresponding to the body measurement that corresponds to that direction. For ease of illustrative representation, these multidimensional vectors are represented in FIG. 2 as generic geometric shapes 231, 232, 233, 234, 235 and 236, where like shapes represent similar vectors. As shown in the system 200 of FIG. 2, therefore, information from the exemplary set of rigged body models 131, 132, 133, 134, 135 and 136 can be utilized to derive and approximate body measurement values which can then be stored in the form of vectors in what can be referred to as “measurement space”, where the measurement space vectors 231, 232, 233, 234, 235 and 236 correspond to the exemplary set of rigged body models 131, 132, 133, 134, 135 and 136, respectively. As utilized herein, the term “measurement space” can refer to a multidimensional mathematical construct where each dimension corresponds to a particular body measurement, such as height, weight, neck size, and the like.

Once the rigged body models have been converted to corresponding measurement space vectors, such as shown in the system 200 of FIG. 2, duplicate, or approximately duplicate, vectors can be eliminated. As an oversimplified example, if the only body measurement that was relevant was height, the measurement space vectors 231, 232, 233, 234, 235 and 236 would comprise only the height value. As such, two or more rigged body models that described human bodies that were of the same height would result in equal measurement space vectors even though the described human bodies and, consequently, the rigged body models based on them, could be very different, such as, for example, having vastly different weights.

In one embodiment, the dimensionality of measurement space can be defined by the type and quantity of different body measurements that can be solicited from a user. In such an embodiment, the conversion of rigged body models to measurement space vectors, as shown in the system 200 of FIG. 2, and as described in detail above, can be performed once for multiple different user-entered body measurements. Indeed, in such an embodiment, the conversion of rigged body models to measurement space vectors can be pre-computed.

In an alternative embodiment, however, the dimensionality of measurement space can be defined by the type and quantity of different body measurements that were actually provided by the user. In such an alternative embodiment, if the user were only to provide a few body measurements, the dimensionality of measurement space can be fairly small and, consequently, many more measurement space vectors can be equivalent, or approximately equivalent, resulting in a determination that many more rigged body models are, for purposes of the body measurements actually entered by the user, equivalent, or approximately equivalent. Additionally, in such an alternative embodiment, the conversion of rigged body models to measurement space vectors may not necessarily be able to be pre-computed, since it may not be known, in advance, which body measurements the user will provide.

One mechanism for comparing the measurement space vectors 231, 232, 233, 234, 235 and 236 can be Principal Component Analysis (PCA). As will be known by those skilled in the art, applying PCA to the measurement space vectors 231, 232, 233, 234, 235 and 236 can result in a reduced set of measurement space vectors 232, 233, 234 and 235 that can have eliminated duplicate vectors, or approximately duplicate vectors, such as, for example, the measurement space vectors 231 and 236. In other embodiments, other analytics can be applied in place of PCA to eliminate duplicate, or approximately duplicate, measurement space vectors. For example, a classification filter can likewise be utilized to obtain the reduced set of measurement space vectors 232, 233, 234 and 235.

As shown in the system 200 of FIG. 2, once a reduced set of measurement space vectors 232, 233, 234 and 235 is obtained, that reduced set of measurement space vectors can be compared to a user-entered measurement space vector 240 that is based on the body measurements provided by the user. As would be obvious to those skilled in the art, the user-entered measurement space vector 240 can comprise those quantities provided by the user, such as through a user-interface, such as the exemplary user interface 140 shown in FIG. 1 and described in detail above. However, for any qualitative body aspects provided by the user, such as overall shape, or the shape of individual aspects, a conversion to quantitative measurements, such as that described in detail above, can be performed to generate the user-entered measurement space vector 240. To ensure conformity between the user-entered measurement space vector 240 and the reduced set of measurement space vectors 232, 233, 234 and 235, the same, or an equivalent, conversion mechanism can be utilized. In one embodiment, the user-entered measurement space vector 240 can be expressed as a combination of fractions of the individual vectors of the reduced set of measurement space vectors 232, 233, 234 and 235. For example, as illustrated in FIG. 2, the user-entered measurement space vector 240 can be found to be a combination of 75% of the measurement space vector 232, represented in FIG. 2 as measurement space vector 242, 5% of the measurement space vector 233, represented in FIG. 2 as measurement space vector 243, 19% of the measurement space vector 234, represented in FIG. 2 as measurement space vector 244, and 1% of the measurement space vector 235, represented in FIG. 2 as measurement space vector 245. In another embodiment, not specifically illustrated in FIG. 2, the fractional combination of measurement space vectors from the reduced set of measurement space vectors can have a lower limit threshold such that, for example, the fractional portion of the measurement space vector 235 can be rounded down to zero instead of the 1% represented by the vector 245.

In one embodiment, the determination of the fractional vectors 242, 243, 244 and 245 that can be summed to comprise the user-entered measurement space vector 240 can be based on a Least Square Error (LSE) analysis. As will be recognized by those skilled in the art, an LSE analysis can identify the combination of measurement space vectors that is the closest, in measurement space, to the user-entered measurement space vector 240. As before, other analytics can likewise be utilized in place of LSE analysis to identify a fractional combination of measurement space vectors that can represent, at least an approximation of, the user-entered measurement space vector 240.

Subsequently, as shown in the system 200 of FIG. 2, the rigid body models corresponding to the fractional measurement space vectors 242, 243, 244 and 245 that have been determined to represent the user-entered measurement space vector 240, can be summed in the same fractional proportions to achieve a best-fit rigged body model 250. Thus, in the illustrated example of FIG. 2, the best-fit rigged body model 250 can be created by summing a combination of 75% of the rigged body model 132, represented in FIG. 2 as the rigged body model 252, 5% of the rigged body model 133, represented in FIG. 2 as rigged body model 253, 19% of the rigged body model 134, represented in FIG. 2 as rigged body model 254, and 1% of the rigged body model 135, represented in FIG. 2 as rigged body model 255, where the rigged body models 132, 133, 134 and 135 are the rigged body models corresponding to the measurement space vectors 232, 233, 234 and 235 whose fractional summation was calculated to best represent the user-entered measurement space vector 240.

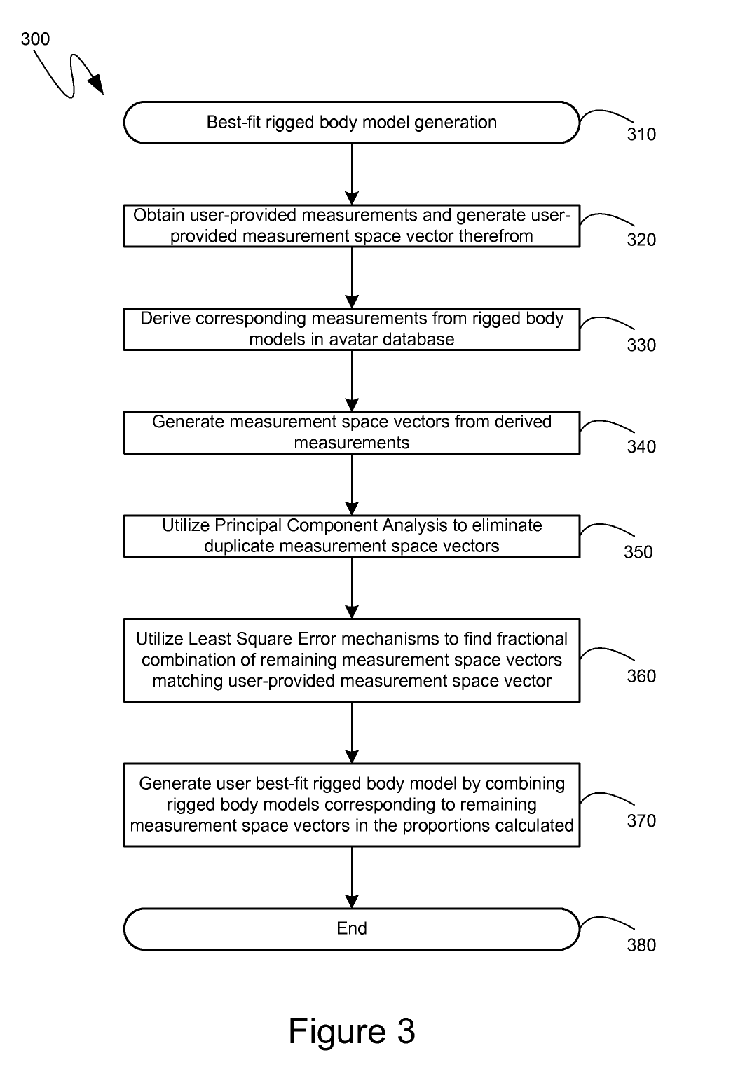

Turning to FIG. 3, the flow diagram 300 shown therein illustrates an exemplary series of steps by which a best-fit rigged body model can be generated based on body measurements provided by a user. Initially, as shown, a best-fit rigged body model generation can be initiated at step 310. Subsequently, at step 320, user-provided body measurements can be obtained and a user-provided measurement space vector can be generated from those provided body measurements. At step 330, corresponding body measurements can be derived for the known, existing rigged body models in a pre-determined set of body models or the avatar database. Subsequently, at step 340, measurement space vectors can be generated from the body measurements that were derived at step 330. As indicated previously, in one embodiment, step 330 can be performed prior to the initiation of the best-fit rigged by the model generation at step 310. Such a pre-computation can be performed irrespective of whether the dimensionality of measurement space is dependent upon the type and quantity of body measurements actually provided by the user at step 320. However, in an embodiment in which the dimensionality of measurement space is independent of the type and quantity of body measurements actually provided by the user at step 320, the generation of measurement space vectors, at step 340, can also be performed, like the derivation of body measurements at step 330, prior to the initiation of the best-fit rigged body model generation at step 310.

After the measurement space vectors for the existing rigged body models have been generated at step 340, processing can proceed to step 350 at which point duplicate, or approximately duplicate, measurement space vectors from among those generated at step 340, can be removed. In one embodiment, such a filtering of the measurement space vectors generated at step 340 can be performed, at step 350, using PCA. In other embodiments, however, as indicated previously, other analytics can be used at step 350 to filter the measurement space vectors generated at step 340.

Subsequently, at step 360, the remaining measurement space vectors, after the filtering step 350, can be utilized to find a fractional combination thereof that can most closely represent the user-provided measurement space vector generated at step 320. In one embodiment, the finding, at step 360, of the fractional combination of measurement space vectors that most closely represents the user-provided measurement space vector can be performed using an LSE analysis. In other embodiments, however, as indicated previously, other analytics can be used at step 360 to derive the fractional combination of measurement space vectors that most closely represent the user-provided measurement space vector.

At step 370, a best-fit rigged body model can be generated by combining, in the fractional combination computed at step 360, the rigged body models corresponding to the measurement space vectors whose fractional combination was computed at step 360. The relevant processing can then end at step 380.

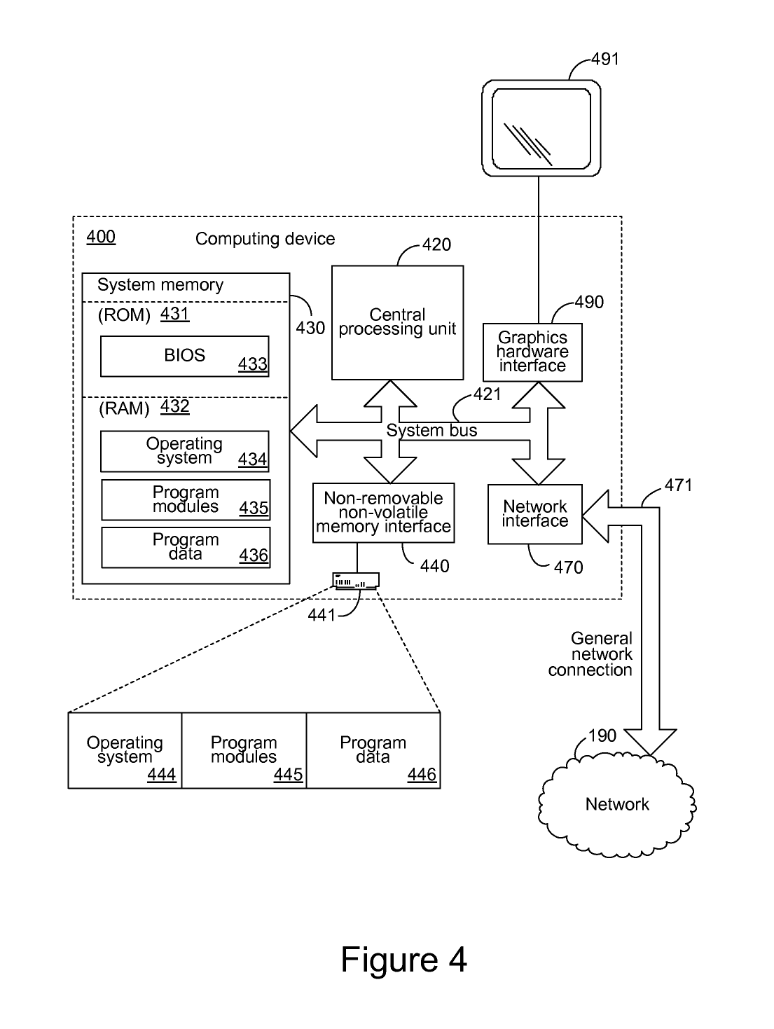

The above descriptions reference actions performed by computer-executable instructions executing on one or more computing devices. Turning to FIG. 4, one such exemplary computing device 400 is illustrated. Such an exemplary computing device 400 can be any one of the computing device 110 or 120, described above and shown in FIG. 1, or any other like computing device.

The exemplary computing device 400 of FIG. 4 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 490 and a display device 491. Such graphics hardware, including the graphics hardware interface 490 and a display device 491, can be utilized to, not only display the above-described interfaces and rigged body models, if appropriate, but also, in some embodiments, to perform some or all of the relevant computation and processing, that was also described in detail above.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

Additionally, the computing device 400 may operate in a networked environment using logical connections to one or more remote computers. For simplicity of illustration, the computing device 400 is shown in FIG. 4 to be connected to the network 190, originally illustrated in FIG. 1. The network 190 is not limited to any particular network or networking protocols. Instead, the logical connection depicted in FIG. 4 is a general network connection 471 that can be a local area network (LAN), a wide area network (WAN) or other network. The computing device 400 is connected to the general network connection 471 through a network interface or adapter 470 which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 471. It will be appreciated that the network connections shown are exemplary and other means of establishing a communications link between computing devices may be used.

As can be seen from the above descriptions, mechanisms for generating a best-fit rigged body model corresponding to user-provided body measurements have been provided. In view of the many possible variations of the subject matter described herein, we claim as our invention all such embodiments as may come within the scope of the following claims and equivalents thereto.

We claim:

1. One or more computer-readable media comprising computer-executable instructions for generating a best-fit rigged body model, the computer-executable instructions directed to steps comprising:
deriving body measurements from existing rigged body models;
generating vectors in measurement space from the derived body measurements of the existing rigged body models;
filtering the generated vectors to remove duplicates;
generating a user-entered vector in measurement space from user-entered body measurements;
calculating a combination of fractions of the filtered generated vectors that matches the generated user-entered vector in measurement space; and
combining existing rigged body models that correspond to the filtered generated vectors whose fractional combination matched the generated user-entered vector, in proportions defined by the fractions, to generate the best-fit rigged body model.

2. The computer-readable media of claim 1, further comprising computer-executable instructions for providing a user interface through which a user can enter the user-entered body measurements.

3. The computer-readable media of claim 1, wherein the measurement space comprises a dimensionality equivalent to potential user-entered body measurement types.

4. The computer-readable media of claim 1, wherein the measurement space comprises a dimensionality equivalent to type of user-entered body measurement actually provided by a user.

5. The computer-readable media of claim 1, wherein the filtering is performed using Principal Component Analysis.

6. The computer-readable media of claim 1, wherein the filtering further removes at least one vector of a set of vectors that are essentially duplicative of one another.

7. The computer-readable media of claim 1, wherein the matching of the combination of fractions of the filtered generated vectors to the generated user-entered vector is performed by determining a Least Square Error, in measurement space, between combination of fractions of the filtered generated vectors and the generated user-entered vector.

8. The computer-readable media of claim 1, wherein the deriving the body measurements from the existing rigged body models is performed prior to obtaining the user-entered body measurements.

9. A method of generating a best-fit rigged body model, the method comprising the steps of:
deriving body measurements from existing rigged body models;
generating vectors in measurement space from the derived body measurements of the existing rigged body models;
filtering the generated vectors to remove duplicates;
generating a user-entered vector in measurement space from user-entered body measurements;
calculating a combination of fractions of the filtered generated vectors that matches the generated user-entered vector in measurement space; and
combining existing rigged body models that correspond to the filtered generated vectors whose fractional combination matched the generated user-entered vector, in proportions defined by the fractions, to generate the best-fit rigged body model.

10. The method of claim 9, further comprising the step of providing a user interface through which a user can enter the user-entered body measurements.

11. The method of claim 9, wherein the measurement space comprises a dimensionality equivalent to potential user-entered body measurement types.

12. The method of claim 9, wherein the measurement space comprises a dimensionality equivalent to type of user-entered body measurement actually provided by a user.

13. The method of claim 9, wherein the filtering is performed using Principal Component Analysis.

14. The method of claim 9, wherein the filtering further removes at least one vector of a set of vectors that are essentially duplicative of one another.

15. The method of claim 9, wherein the matching of the combination of fractions of the filtered generated vectors to the generated user-entered vector is performed by determining a Least Square Error, in measurement space, between combination of fractions of the filtered generated vectors and the generated user-entered vector.

16. The method of claim 9, wherein the deriving the body measurements from the existing rigged body models is performed prior to obtaining the user-entered body measurements.

17. A computer-readable medium comprising:
existing rigged body models;
body measurements associated with the existing rigged body models; and
computer-executable instructions for generating a best-fit rigged body model, the computer-executable instructions directed to steps comprising: generating vectors in measurement space from the body measurements; filtering the generated vectors to remove duplicates; generating a user-entered vector in measurement space from user-entered body measurements; calculating a combination of fractions of the filtered generated vectors that matches the generated user-entered vector in measurement space; and combining existing rigged body models that correspond to the filtered generated vectors whose fractional combination matched the generated user-entered vector, in proportions defined by the fractions, to generate the best-fit rigged body model.

18. The computer-readable medium of claim 17, wherein the computer-readable medium further comprises computer-executable instructions for providing a user interface through which a user can enter the user-entered body measurements.

19. The computer-readable medium of claim 17, wherein the filtering is performed using Principal Component Analysis.

20. The computer-readable medium of claim 17, wherein the filtering further removes at least one vector of a set of vectors that are essentially duplicative of one another.
